(19) United States
(12) Patent Application Publication
(10) Pub. No.: US 2025/0081943 A1
(43) Pub. Date: Mar. 13, 2025

(54) PET BIRD CARRIER DEVICE

(71) Applicant: Constance Tucker, Cincinnati, OH (US)

(72) Inventor: Constance Tucker, Cincinnati, OH (US)

(21) Appl. No.: 18/427,143

(22) Filed: Jan. 30, 2024

Related U.S. Application Data
(60) Provisional application No. 63/581,775, filed on Sep. 11, 2023.

(51) Int. Cl. A01K 31/07

(52) U.S. Cl. CPC A01K 31/07

(57) ABSTRACT

A bird pet carrier device is provided. The device is comprised of a pet carrier optimized for bird usage. More specifically, the carrier is comprised of a perforated body that does not allow a bird to chew on/through the body. The device further has a door and lock that are reinforced to prevent a bird from destroying/opening the door or lock. In addition, the interior space of the device is comprised of at least one perch.

### CROSS-REFERENCE TO RELATED APPLICATION

The present application claims priority to, and the benefit of, U.S. Provisional Application No. 63/581,775, which was filed on Sep. 11, 2023, and is incorporated herein by reference in its entirety.

### FIELD OF THE INVENTION

The present invention relates generally to the field of pet carriers. More specifically, the present invention relates to a pet bird carrier device with a body that cannot be chewed on/through by a bird and also has at least one perch. Accordingly, the present disclosure makes specific reference thereto. Nonetheless, it is to be appreciated that aspects of the present invention are also equally applicable to other like applications, devices, and methods of manufacture.

### BACKGROUND

Existing pet carriers known in the art are predominantly designed with cats and dogs in mind. This focus on traditional pets has led to a significant oversight in their design as these carriers are not suitably equipped for transporting birds. A primary limitation of said carriers is the absence of perches, which are essential for a bird's comfort and stability during transport. Additionally, the conventional construction of pet carriers involves the use of plastic materials. While this material may be suitable for cats and dogs, it poses a problem for birds as carrier walls typically feature large openings for air circulation, which are not resistant to the strong beaks of birds. Consequently, a bird housed within such a carrier can easily chew on the walls/openings. This chewing is not merely a nuisance but poses a significant threat to the carrier's structural integrity. Over time the damage inflicted by a bird can be extensive enough to compromise the carrier's ability to contain a bird.

Therefore, there exists a long-felt need in the art for an improved pet carrier. There also exists a long-felt need in the art for a bird pet carrier device. In addition, there exists a long-felt need in the art for a bird pet carrier device that is optimized for bird usage. More specifically, there exists a long-felt need in the art for a bird pet carrier device that is optimized for bird usage. Further, there exists a long-felt need in the art for a bird pet carrier device that prevents a bird from chewing on/escaping from the carrier. In addition, there exists a long-felt need in the art for a bird pet carrier device that prevents a bird from chewing on/escaping from the carrier and wherein the device has at least one perch.

The subject matter disclosed and claimed herein, in one embodiment thereof, comprises a bird pet carrier device. The device is comprised of a pet carrier optimized for bird usage. More specifically, the carrier is comprised of a perforated body that does not allow a bird to chew on/through the body. The device further has a door and lock that are reinforced to prevent a bird from destroying/opening the door or lock. In addition, the interior space of the device is comprised of at least one perch. The interior space may also have at least one toy for the bird.

In this manner, the bird pet carrier device of the present invention accomplishes all the foregoing objectives and provides an improved pet carrier optimized for bird usage. More specifically, the device is constructed to prevent a bird from chewing on/escaping from the carrier. Further, the device has at least one perch.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bird pet carrier device. The device provides a pet carrier specifically designed for, and to transport birds. In one embodiment, the device is comprised of a one-piece body. In another embodiment, the device is comprised of a two-piece body comprised of a first half and a second half. In this embodiment, both halves are comprised of at least one opening through which at least one fastener (such as, but not limited to, a bolt and nut assembly) can be placed and used to secure the first half to the second half. The body is preferably made from an aluminum material that is comprised of at least one opening (in a perforated fashion) that acts as an air hole. The opening is preferably not large enough to allow a bird inside the body to bite, break, or pass through.

The body is also comprised of at least one door that attaches to the body via at least one hinge (of any hinge type). The door locks to the body via at least one locking member of any type known in the art, but that is preferably a spring lock. In one embodiment, the door and/or lock may be reinforced by rivets or other structures to prevent a bird inside the device from opening the door and/or lock.

The interior space of the body is comprised of at least one perch. In one embodiment, the perch is repositionable within the interior space. In this embodiment, the perch attaches to and/or through the interior surface of the body via at least one fastener. The interior space may also be comprised of at least one toy of any type of pet/bird toy known in the art. The toy may be attached/hung within the interior space via at least one fastener.

The present invention is also comprised of a method of using the device. First, a device is provided comprised of a body, a door attached to the body by at least one hinge, and at least one perch positioned within the body. Then, a user can position and secure the perch within an interior space of the body. Then, a user can place a bird into the interior space, close the door, and lock the door to the body via the lock. Then, at least one cover can be placed over the lock to prevent the bird from opening/tampering with the door and/or lock.

Accordingly, the bird pet carrier device of the present invention is particularly advantageous as it provides an improved pet carrier optimized for bird usage. More specifically, the device is constructed to prevent a bird from chewing on/escaping from the carrier. Further, the device has at least one perch. In this manner, the bird pet carrier device overcomes the limitations of existing pet carriers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a bird pet carrier device of the present invention in accordance with the disclosed architecture;

FIG. 2 illustrates a perspective view of one potential embodiment of a first half of a bird pet carrier device of the present invention wherein the body has a two-piece construction in accordance with the disclosed architecture;

FIG. 3 illustrates a front perspective view of an interior space of one potential embodiment of a bird pet carrier device of the present invention while the door is open in accordance with the disclosed architecture;

FIG. 4 illustrates a front perspective view of one potential embodiment of a bird pet carrier device of the present invention while the door is closed in accordance with the disclosed architecture; and

FIG. 5 illustrates a flowchart of a method of using one potential embodiment of a bird pet carrier device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pet carrier. There also exists a long-felt need in the art for a bird pet carrier device. More specifically, there exists a long-felt need in the art for a bird pet carrier device that is optimized for bird usage. Further, there exists a long-felt need in the art for a bird pet carrier device that prevents a bird from chewing on/escaping from the carrier. In addition, there exists a long-felt need in the art for a bird pet carrier device that prevents a bird from chewing on/escaping from the carrier and wherein the device has at least one perch.

The present invention, in one exemplary embodiment, is comprised of a bird pet carrier device comprised of a pet carrier specifically designed for, and to transport birds. In one embodiment, the device is comprised of a one-piece body. In another embodiment, the device is comprised of a two-piece body comprised of a first half and a second half, wherein both halves are comprised of at least one opening through which at least one fastener (such as, but not limited to, a bolt and nut assembly) can be placed and used to secure the first half to the second half. The body is preferably made from an aluminum material that is comprised of at least one opening (in a perforated fashion) that acts as an air hole, wherein the opening is preferably not large enough to allow a bird inside the body to bite, break, or pass through.

The body is also comprised of at least one door that attaches to the body via at least one hinge (of any hinge type). The door locks to the body via at least one locking member of any type known in the art, but that is preferably a spring lock. In one embodiment, the door and/or lock may be reinforced by rivets or other structures to prevent a bird inside the device from opening the door and/or lock.

The interior space of the body is comprised of at least one perch. In one embodiment, the perch is repositionable within the interior space. In this embodiment, the perch attaches to and/or through the interior surface of the body via at least one fastener. The interior space may also be comprised of at least one toy of any type of pet/bird toy known in the art. The toy may be attached/hung within the interior space via at least one fastener.

The present invention is also comprised of a method of using the device. First, a device is provided comprised of a body, a door attached to the body by at least one hinge, and at least one perch positioned within the body. Then, a user can position and secure the perch within an interior space of the body. Then, a user can place a bird into the interior space, close the door, and lock the door to the body via the lock. Then, at least one cover can be placed over the lock to prevent the bird from opening/tampering with the door and/or lock.

Accordingly, the bird pet carrier device of the present invention is particularly advantageous as it provides an improved pet carrier optimized for bird usage. More specifically, the device is constructed to prevent a bird from chewing on/escaping from the carrier. Further, the device has at least one perch. In this manner, the bird pet carrier device overcomes the limitations of existing pet carriers known in the art.

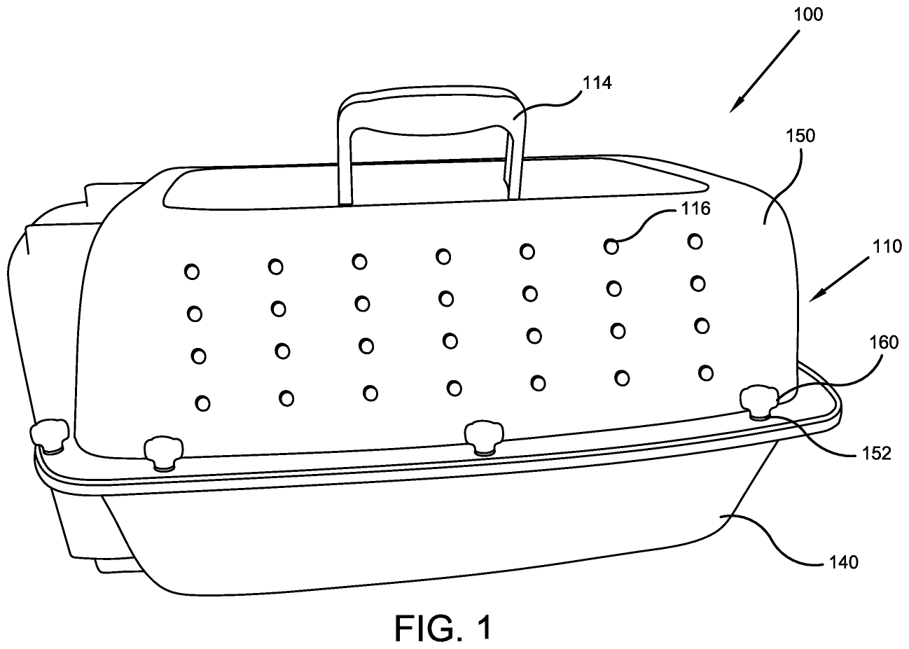

Referring initially to the drawings, FIG. 1 illustrates a perspective view of one potential embodiment of a bird pet carrier device 100 of the present invention in accordance with the disclosed architecture. The device 100 provides a pet carrier specifically designed for, and to transport birds.

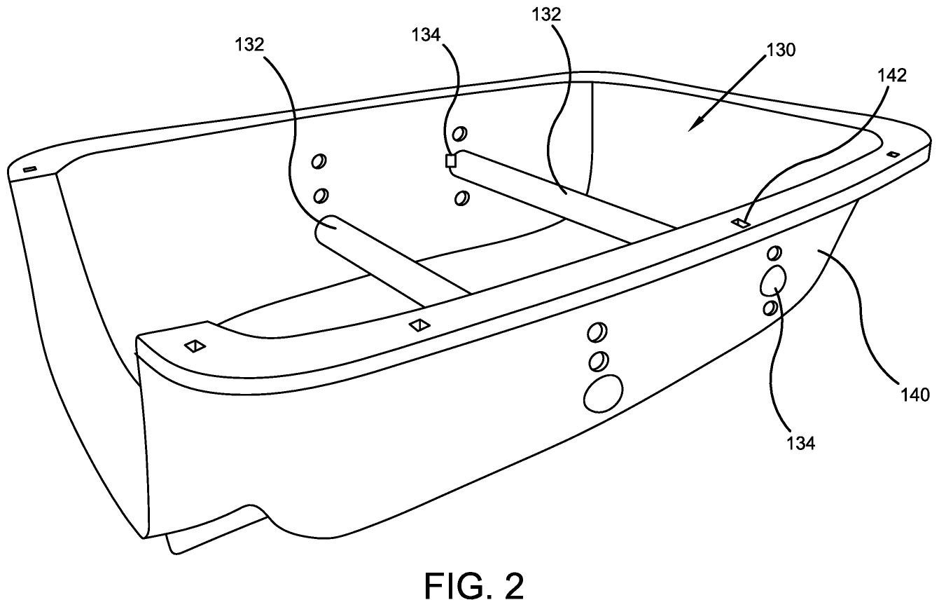

In one embodiment, the device 100 is comprised of a one-piece body 110. In another embodiment, the device 100 is comprised of a two-piece body 110 (partially seen in FIG. 2) comprised of a first half 140 and a second half 150. In this embodiment, both halves 140,150 are comprised of at least one opening 142,152 through which at least one fastener 160 (such as, but not limited to, a bolt and nut assembly) can be placed and used to secure the first half 140 to the second half 150. The body 110 may be made from a plastic or metal material in different embodiments. In one embodiment, the body 110 is made from an aluminum material that is comprised of at least one opening 116 (in a perforated fashion) that acts as an air hole. The opening 116 is preferably not large enough to allow a bird inside the body 110 to bite, break, or pass through. The body 110 may also be comprised of at least one handle 114 of any handle type.

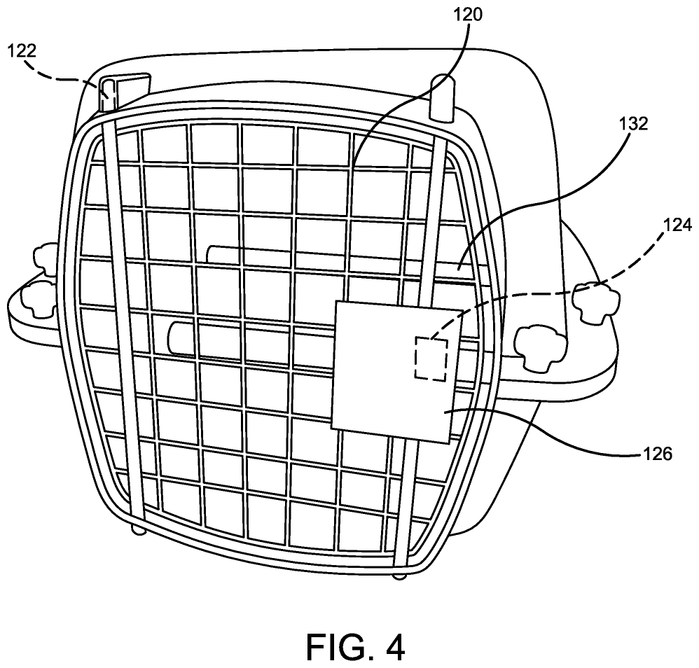

The body 110 is also comprised of at least one door 120. The door 120 attaches to the body 110 via at least one hinge 122 (of any hinge type). The door 120 locks to the body 110 (as seen in FIG. 4) via at least one locking member 124 of any type known in the art, but that is preferably a spring lock. In one embodiment, the door 120 and/or lock 124 may be reinforced by rivets or other structures to prevent a bird inside the device 100 from opening the door 120 and/or lock 124. In one embodiment, the lock 124 is comprised of at least one removable cover 126 that can be placed over the lock 124 once the door 120 is locked to the body 110 to prevent a bird inside the body 110 from accessing and opening the lock 124.

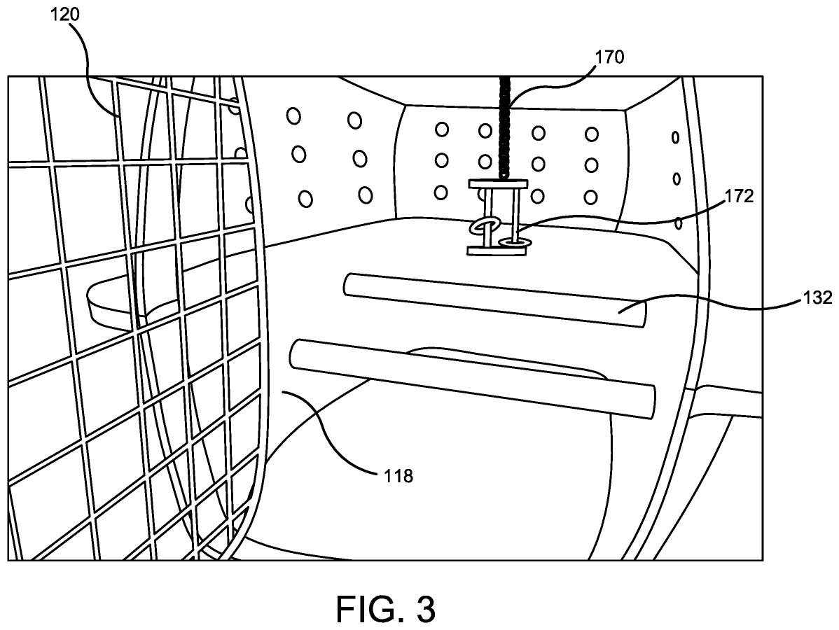

The interior space 130 of the body 110 is comprised of at least one perch 132, as seen in FIG. 2 and FIG. 3. In another embodiment, the perch 132 may be positioned anywhere on the device 100, including externally or internally positioned on the body 110. The perch 132 may be any shape, size, and configuration. In one embodiment, the perch 132 is repositionable within the interior space 130. In this embodiment, the perch 132 attaches to and/or through the interior surface 118 of the body 110 via at least one fastener 134 such as, but not limited to, a tongue, a groove, a hook, a threaded fastener, etc. The perch 132 may attach at a plurality of heights/levels on the interior surface 118.

The interior space 130 may also be comprised of at least one toy 172. The toy 172 may be any type of pet/bird toy known in the art. The toy 172 may be attached/hung within the interior space 130 via at least one fastener 172. The fastener 172 may include, but is not limited to, a hook, a clip, a threaded fastener, etc.

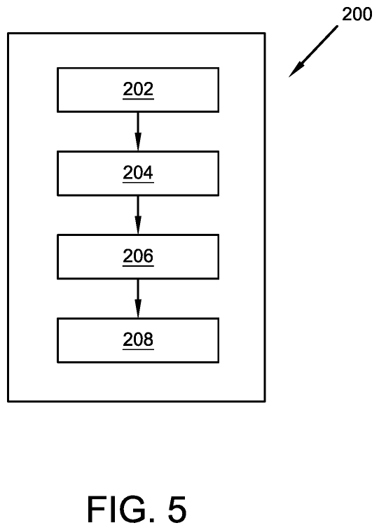

The present invention is also comprised of a method of using 200 the device 100, as seen in FIG. 5. First, a device 100 is provided comprised of a body 110, a door 120 attached to the body 110 by at least one hinge 122, and at least one perch 132 positioned within the body 110 [Step 202]. Then, a user can position and secure the perch 132 within an interior space 130 of the body 110 [Step 204]. Then, a user can place a bird into the interior space 130, close the door 120, and lock the door 120 to the body 110 via the lock 124 [Step 206]. Then, at least one cover 126 can be placed over the lock 124 to prevent the bird from opening/tampering with the door 120 and/or lock 124 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bird pet carrier device” and “device” are interchangeable and refer to the bird pet carrier device 100 of the present invention.

Notwithstanding the foregoing, the bird pet carrier device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bird pet carrier device 100 as shown in the FIGS. are for illustrative purposes only, and that many other sizes and shapes of the bird pet carrier device 100 are well within the scope of the present disclosure. Although the dimensions of the bird pet carrier device 100 are important design parameters for user convenience, the bird pet carrier device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bird pet carrier device comprising:
a body comprised of an interior space;
a door attached to the body, the door comprised of a lock;
a perch positioned within the interior space.

2. The bird pet carrier device of claim 1, wherein the body is comprised of a two-piece body comprised of a first half and a second half.

3. The bird pet carrier device of claim 2, wherein the first half is secured to a second half via a first fastener.

4. The bird pet carrier device of claim 1, wherein the body is comprised of a perforated body.

5. The bird pet carrier device of claim 1, wherein the perch is repositionable within the interior space.

6. The bird pet carrier device of claim 1, wherein the body is comprised of an aluminum material.

7. The bird pet carrier device of claim 1, wherein the interior space is comprised of a toy.

8. The bird pet carrier device of claim 7, wherein the toy attaches to the interior space via a second fastener.

9. A bird pet carrier device comprising:
a body comprised of an interior space;
a reinforced door attached to the body, the door comprised of a lock comprised of a removable cover;
a perch positioned within the interior space.

10. The bird pet carrier device of claim 9, wherein the body is comprised of a two-piece body comprised of a first half and a second half.

11. The bird pet carrier device of claim 10, wherein the first half is secured to a second half via a first fastener.

12. The bird pet carrier device of claim 9, wherein the body is comprised of a perforated body.

13. The bird pet carrier device of claim 9, wherein the perch is repositionable within the interior space.

14. The bird pet carrier device of claim 9, wherein the body is comprised of an aluminum material.

15. The bird pet carrier device of claim 9, wherein the interior space is comprised of a toy.

16. The bird pet carrier device of claim 15, wherein the toy attaches to the interior space via a second fastener.

17. The bird pet carrier device of claim 9, wherein the body is comprised of a handle.

18. A method of using a bird pet carrier device, the method comprising the following steps:
providing a bird pet carrier device comprised of a body, a door attached to the body by at a hinge, and a positioned within the body;
positioning the perch within an interior space of the body;
placing a bird in the interior space;
closing the door and locking the door to the body; and
placing a cover over the lock.

19. The method of using a bird pet carrier device of claim 18, wherein the body is comprised of a perforated body.

20. The method of using a bird pet carrier device of claim 18, wherein the body is comprised of a two-piece body.
